(19) United States
(12) Patent Application Publication
(10) Pub. No.: US 2024/0265237 A1
(43) Pub. Date: Aug. 8, 2024

(54) MODEL-AGNOSTIC EXPLAINABILITY FOR MULTIMODAL ARTIFICIAL INTELLIGENCE MODELS

(71) Applicant: INTERNATIONAL BUSINESS MACHINES CORPORATION, Armonk, NY (US)

(72) Inventors: Vijay Arya, Gurgaon (IN); Diptikalyan Saha, Bangalore (IN); Manish Anand Bhide, Hyderabad (IN); Pratap Kishore Varma Vemulamanda, Hyderabad (IN)

(21) Appl. No.: 18/163,804

(22) Filed: Feb. 2, 2023

(51) Int. Cl. G06N 3/0455; G06N 3/0985

(52) U.S. Cl. CPC G06N 3/0455; G06N 3/0985

(57) ABSTRACT

Explaining decisions or predictions of an AI model can include generating perturbed instances by perturbing one or more encoded features of a multimodal AI model instance. For each of the perturbed instances, a distance between one or more encoded features of each perturbed instance and a corresponding one or more of the encoded features of the multimodal AI instance can be determined. Each distance can be converted to a weight using a kernel function. For each weight, a modality-specific Shapley value can be determined, and each weight can be adjusted by post-weighting each weight with the modality-specific Shapley value associated with the weight to obtain final weights. An interpretable surrogate model based on the final weights can be output.

### BACKGROUND

This disclosure relates to artificial intelligence (AI) models and, more particularly, to explainable AI.

A goal of explainable AI is to provide humanly understandable explanations of how an AI-enabled machine generates decisions or predictions. Just as the real world involves multiple modalities in which humans see objects, hear sounds, feel texture, smell odors, and so forth, AI models likewise rely increasingly on multimodal inputs—text, images, audio, and the like. Multimodal AI models, not surprisingly, are appearing in an ever-wider array of real-world applications such as healthcare, robotics, multimedia, affective computing, and human-computer interaction. As the array of applications of multimodal AI models has grown, so too, has the challenge of making multimodal AI models explainable.

Existing AI explainability tools typically train a surrogate model that renders a local explanation of an AI model. The form of the explanation is a feature importance value, also known as a feature attribution value. Such tools can be used for explaining AI models whose inputs are unimodal, such as tabular data, text, images, or the like. Many of the most widely used AI explainability tools, such as Local Interpretable Model-Agnostic Explanation (LIME), however, do not adequately explain predictions generated with multimodal AI models.

### SUMMARY

In one or more embodiments, a method includes generating a plurality of perturbed instances, each of the perturbed instances generated by perturbing one or more encoded features of a multimodal AI model instance. The method includes determining, for each of the plurality of perturbed instances, a distance between one or more encoded features of each perturbed instance and a corresponding one or more of the encoded features of the multimodal AI instance. The method includes converting each distance to a weight using a kernel function. The method includes determining for each weight a modality-specific Shapley value corresponding to a modality associated with each weight and post-weighting each weight with the modality-specific Shapley value associated with the weight to obtain a plurality of final weights. The method includes outputting an interpretable surrogate model based on the final weights.

In one aspect, perturbed instances are generated independently by perturbing one or more features of each perturbed instance according to the modality of each of the one or more features.

In another aspect, generating perturbed instances is performed using a pretrained autoencoder and/or a generative adversarial network.

In another aspect, determining a distance between one or more encoded features of each perturbed instance and a corresponding one or more of the encoded features of the multimodal AI instance uses a modality-specific distance metric corresponding to a modality of the encoded features for which the distance is determined.

In another aspect, the kernel function for converting each distance is a modality-specific kernel function corresponding to a modality of encoded features for which the distance is determined.

In another aspect, the interpretable surrogate model is a sparse linear model whose weights correspond to feature importance values.

In another aspect, the method further includes iteratively tuning hyperparameters of the interpretable surrogate model by comparing true explanations with outputs generated by the interpretable surrogate model. The true explanations comprise true feature attribution weights generated using a machine learning model (e.g., logistic regression model). The values for the hyperparameters are determined based upon a Pearson correlation coefficient or a normalized discounted cumulative gain.

In one or more embodiments, a system includes one or more processors configured to initiate executable operations as described within this disclosure.

In one or more embodiments, a computer program product includes one or more computer readable storage mediums having program code stored thereon. The program code is executable by a processor to initiate executable operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a computing environment that is capable of implementing a multimodal AI model explainability (MAIME) framework.

FIG. 2 illustrates an example architecture for the executable MAIME framework of FIG. 1.

FIG. 3 illustrates an example method of operation of the MAIME framework of FIGS. 1 and 2.

FIG. 4 schematically illustrates certain operative aspects of the MAIME framework of FIGS. 1 and 2.

FIG. 5 schematically illustrates certain operative aspects of the MAIME framework of FIGS. 1 and 2.

FIG. 6 schematically illustrates certain operative aspects of the MAIME framework of FIGS. 1 and 2.

FIG. 7 schematically illustrates certain operative aspects of the MAIME framework of FIGS. 1 and 2.

FIG. 8 illustrates an example output of the MAIME framework of FIG. 2.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to artificial intelligence (AI) models and, more particularly, to explainable AI. In accordance with the inventive arrangements described herein, methods, systems, and computer program products are provided that are capable of generating explanations explaining the machine-based decisions and predictions of multimodal AI models. The inventive arrangements disclosed herein provide interpretable, model-agnostic explanations of multimodal AI model decisions and predictions. In other arrangements, the inventive arrangements use machine learning (e.g., logistic regression) to fine tune the hyperparameters of an AI explainability model and to determine the accuracy of the AI model explanations generated by the model.

In one aspect of the inventive arrangements disclosed herein, a game-theoretic Shapley value is uniquely determined for each modality of a perturbed multimodal data instance. Perturbed multimodal data instances are generated for a local data instance produced by a multimodal AI model. Weights for each modality of each of the perturbed multimodal data instances are determined based on distances between the local data instance and each of the perturbed multimodal data instances, which lie in a neighborhood surrounding the local data instance.

Each input to the particular multimodal AI model can comprise multiple modalities. The multiple modalities can include text, tabular, numerical, image, and other types of data. The input, for example, to a healthcare-oriented multimodal AI model may comprises image data (e.g., a first modality), such as x-rays or MRI scans, as well as text data (e.g., a second modality) corresponding to a physician's comments on the image data. For example, the input to a multimodal AI model designed to predict customer purchases may comprise e-commerce customer data in which each input includes tabular data (e.g., a first modality) of customer attributes as well as a customer review made up of a long sequence of text data (e.g., a second modality).

The different modalities of the features of a perturbed multimodal AI model instance pose a significant challenge to explaining predictions or decisions of the multimodal AI model. For example, if the instances are encoded in a multidimensional vector space, the vectorial distances along a numerical feature axis may not vary greatly, whereas for words of text the distances of word feature encodings may vary greatly. The much greater distance owing to word embeddings of text can overwhelm the features distances with respect to the numerical features, for example. In one aspect of the inventive arrangements disclosed herein, the modal distances are re-weighted to avoid one feature's modality obscuring the explanatory significance of a feature with a different modality. The reweighting uses game-theoretic Shapley values. A relative weight of each modality is determined by multiplying each modality's distance-based weight by a corresponding Shapley value determined for each distinct modality.

In another aspect, the relative, Shapley-adjusted weights based on corresponding Shapley values can be used to train a surrogate model. The surrogate model (e.g., a sparse linear model) determines feature importance values for various data features. In certain arrangements, the feature importance is a feature importance weight, or feature attribution weight, whose value indicates a relative importance of a feature having a specific modality.

In still another aspect, various hyperparameters are fined tuned to enhance the accuracy of the explanation generated based on local perturbations of AI model data instances. The fine tuning can pertain to hyperparameters related to perturbation methods, distance functions, kernel functions, and the surrogate model.

In yet another aspect, the AI explainability provided by the inventive arrangements disclosed are model-agnostic explanations. That is, the AI explainability is independent of the particular multimodal AI model that generated a decision or prediction that is explained by the inventive arrangements. The multimodal AI model, for example, can be a deep learning neural network, decision tree, random forest, or other black-box AI model that generates decisions or predictions using multimodal data.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

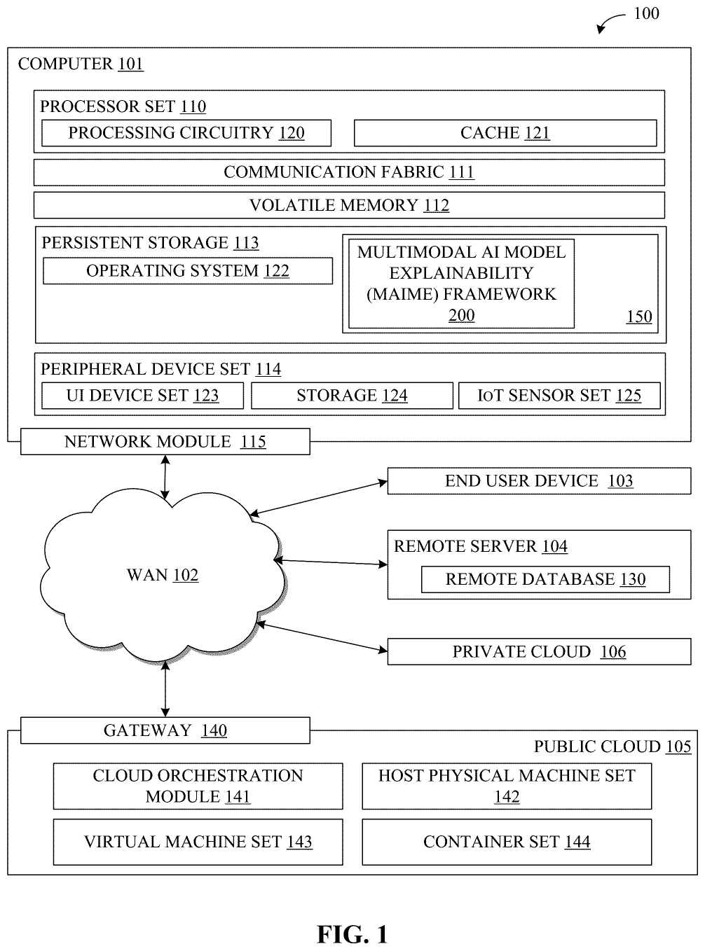

Referring to FIG. 1, computing environment 100 contains an example of an environment for the execution of at least some of the computer code in block 150 involved in performing the inventive methods, such as multimodal AI model explainability (MAIME) framework 200 implemented as executable program code or instructions. MAIME framework 200 is capable of generating an explanation explaining machine-based decisions and predictions of a multimodal AI model.

Computing environment 100 additionally includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and MAIME framework 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

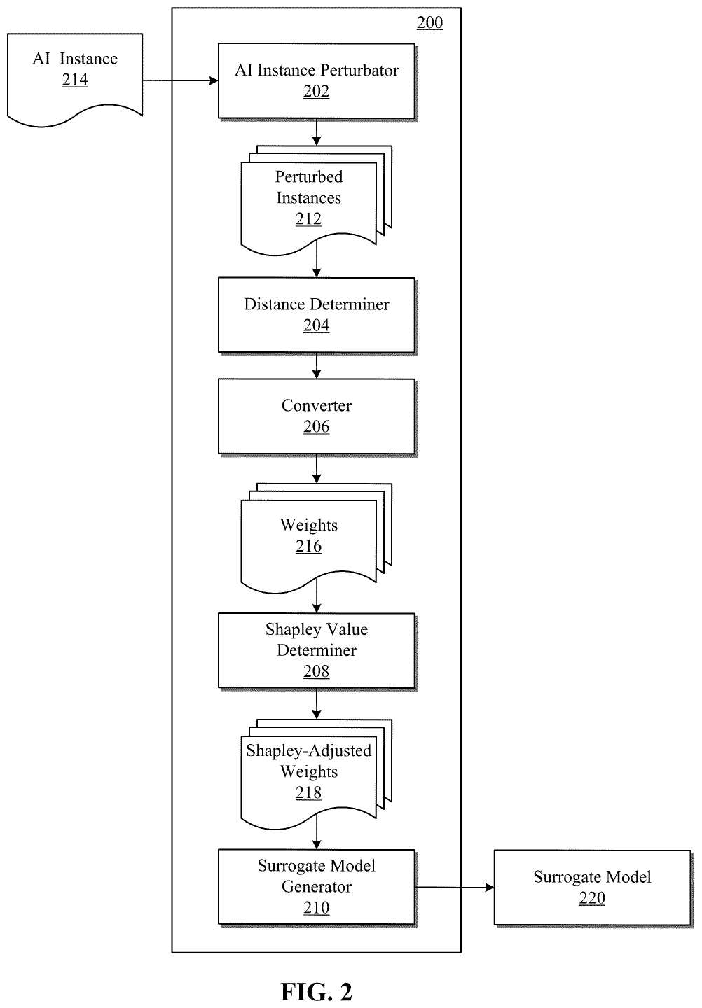

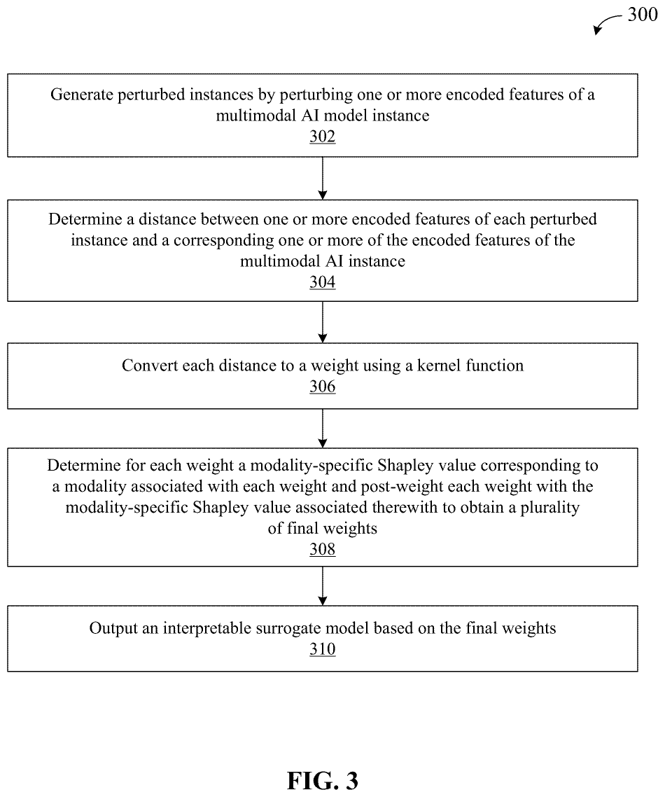

FIG. 2 illustrates an example architecture for the executable MAIME framework 200 of FIG. 1. In the example of FIG. 2, MAIME framework 200 illustratively includes AI instance perturbator 202, distance determiner 204, converter 206, Shapley value determiner 208, and surrogate model generator 210. FIG. 3 illustrates an example method 300 of operation of the MAIME framework 200 of FIGS. 1 and 2.

Referring to FIGS. 2 and 3 collectively, in block 302, AI instance perturbator 202 generates perturbed instances 212 by perturbating multimodal AI instance 214, which is generated by a multimodal AI model. Each of perturbed instances 212 can correspond to a perturbation of multimodal AI instance 214 with respect to features having different modalities (e.g., text, numerical, image). In certain embodiments, each of perturbed instances 212 is generated by perturbing one or more of the different features of multimodal AI instance 214. In some embodiments, the features that have different modalities are perturbed independently of each other, either simultaneously or serially.

In some embodiments, for example, AI instance perturbator 202 implements an artificial neural network autoencoder. The autoencoder can learn to generate perturbed instances, the learning based on the input of multiple AI model instances generated by the same multimodal AI model that generates multimodal AI instance 214. By randomly perturbing one or more encoded features of multimodal AI instance 214, the autoencoder can generate a perturbed instance. Perturbed instances 212 are generated repeating the procedure multiple times. In other embodiments, AI instance perturbator 202 implements a generative adversarial network (GAN) for generating perturbed instances 212. Given a training set of AI model instances generated by the same multimodal AI model that generates multimodal AI instance 214, the GAN can learn to generate perturbed instances 212 based on the same statistical properties of the training set. In still other embodiments, AI instance perturbator 202 can be configured to implement other techniques for generating perturbed instances 212, each perturbed instance generated by perturbing one or more features of multimodal AI model instance 214.

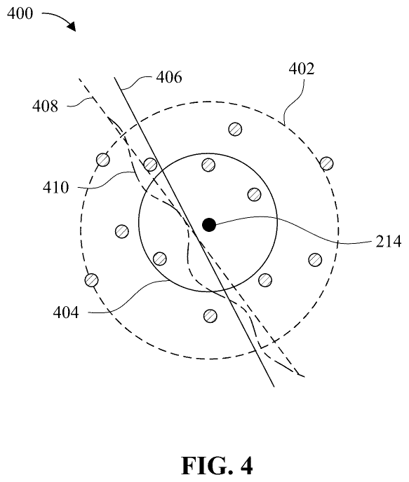

At block 304, determiner 204 determines for each of perturbed instances 212 a distance with respect to multimodal AI instance 214. Each of perturbed instances 212 and multimodal AI instance 214 can be encoded as a feature vector in an embedding space (a vector space). Different features of perturbed instances 212 and multimodal AI instance 214 can have different modalities. The modality for features corresponding to word encodings, for example, is text. Another can feature modality can be an image modality for features corresponding to pixel values of an image, for example. A distance between one of perturbed instances 212 and multimodal AI instance 214 can be a distance between one or more encoded features of the perturbed instance and a corresponding one or more encoded features of multimodal AI instance 214. Thus, a distance between each text feature, numerical feature, image feature, or feature of another modality of a perturbed instance is determined with respect to the corresponding text, numerical, image or other modality feature of multimodal AI instance 214. In the context of a neighborhood of perturbed instances, multimodal AI instance 214 is a local instance, which is at, or near, the center of the neighborhood of perturbed instances. (See FIG. 4.) Each perturbation of the local instance generates a new point or vector in the neighborhood of the local instance.

In various embodiments, different distance functions can be implemented by determiner 204. The different distance functions can be determined according to the specific modality of the features from which the distance is determined. For example, distances based on differences between numerical and/or image features of perturbed instances 212 and multimodal AI instance 214 can be determined as Euclidean distances. By contrast, distances based on differences between text features of perturbed instances 212 and multimodal AI instance 214 can be determined based on cosine similarity. Thus, in each instance, the distances determined by determiner 204 can be determined by a modality-specific distance metric (e.g., Euclidean distance, cosine similarity, Manhattan distance).

At block 306, converter 206 converts the distances to weights 216. In certain embodiments, converter 206 implements a kernel function that converts distances to corresponding weights. A kernel function maps distances from one embedding space to another. For example, each distance can be mapped to a weight whose value is between zero and one. Each weight can be determined by converter 206 implementing a modality-specific kernel function for each of the different modalities of the features of perturbed instances 212 and modal AI model instance 214 for which the distances are determined. Thus, various kernel functions can be implemented by converter 206. The kernel functions implemented by converter 206 in different embodiments, for example, can include one or more exponential kernel functions, one or more Gaussian kernel functions, and/or one or more other types of other kernel functions. The parameters of each of the kernel functions can be determined for each specific modality.

As noted already, different modalities pose a challenge for multimodal AI explainability because one modality may dominate another. For example, distances between encoded representations of text (one modality) may dominate distances between encoded representations of numerical data (another modality). The dominance of one modality over another makes it difficult to determine the relative importance of features having different modalities in explaining a decision or prediction of the multimodal AI model. To address the effects of multiple modalities, MAIME framework 200 includes Shapley value determiner 208. Shapley value determiner 208 generates Shapley-adjusted weights 218 by post-weighting weights 216, which are generated based on distances between encoded features of perturbed instances 212 and multimodal AI instance 214.

At block 308, Shapley value determiner 208 determines for each modality a corresponding Shapley value. Each Shapley value corresponds to the effect that a coalition of some combination of features has on explaining the prediction of the AI model that generates multimodal AI instance 214. Shapley value determiner 208 performs a post-weighting of each of the distance-based weights to determine a set of final weights corresponding to perturbed multimodal AI instance 214. In using Shapley values, which generally correspond to different players in an N-player game, players may be substituted with modalities. Thus, for an N-player game, if v(S) is the value or worth of coalition S (a combination of n distinct modalities), then the Shapley value s(i) for modality i is given by

$$= {\sum }_{S ⊆ N \backslash \{ i \} , s = \vert S \vert} \frac{( n - s - 1 ) ! s !}{n !} ( v ( S ⋃ \{ i \} ) - v ( S ) )$$

For example, the Shapley value for text, assuming that the “game” includes only two modalities, text and numerical data, is an average of the difference between the contribution to the model prediction of text data alone and the difference between the contribution of a “coalition” of text and numerical data and numerical data alone:

$$\frac{1}{2} \{ v ( text ) - v ( null ) \} + \frac{1}{2} \{ v ( text , num ) - v ( num ) \} .$$

Here v(text) can be computed by averaging the model predictions of k samples in the training data wherein the text features remain fixed from the current multimodal sample to be explained, and numerical features vary. Similarly, v(num) is computed by averaging the model predictions of k samples from training data wherein the numerical features remain fixed based on the current sample to be explained and text features vary. v(null) is computed by averaging model predictions of k samples from training data. k can be set as a fraction of the training data, based on the available compute power.

Each Shapley value corresponds to a corresponding feature's contribution to multimodal AI model instance 214's prediction or decision versus what the likely prediction or decision would have been without the feature, the feature having a specific modality.

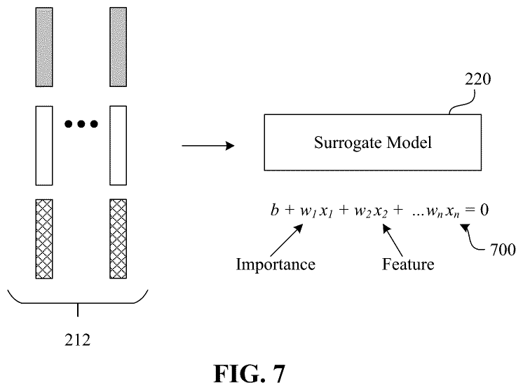

At block 310, surrogate model generator 210 generates surrogate model 220. Surrogate model 220 is an interpretable model generated using the set of final weights, that is, the distance-based weights post-weighted by Shapley values corresponding to each modality. Surrogate model generator 210 generates surrogate model 220 by fitting a model to perturbed instances 212, each weighted by a final, Shapley-adjusted weight. Surrogate model 220, in certain embodiments, is a sparse linear model (e.g., ridge regression) comprising weighted variables, the variables corresponding to features and their weights corresponding to the importance of the feature (feature importance weights). (See FIG. 7.) The feature importance weights indicate which features most likely explain the decision or prediction generated by the AI model that generated multimodal AI instance 214.

MAIME framework 200 is also capable of fine tuning the hyperparameters for reaching AI explainability with respect to the AI model. The fine tuning is based on comparing MAIME framework-determined explanations of the AI model with true explanations computed via a machine learning model (e.g., logistic regression) trained on multiple datasets. MAIME framework 200 fits the model to the datasets and computes true feature attribution weights based on weights computed by the model. MAIME framework 200 evaluates the explainability on multiple datasets and compares these with explanations computed via the model using any of a variety of metrics. The metrics can include, for example, a Pearson correlation coefficient. The metrics can include a normalized discounted cumulative gain (NDCG) score. Based on the metrics, MAIME framework 200 determines the best-performing hyperparameters.

MAIME framework 200, in certain embodiments, fits a logistic regression model on a plurality of different problem sets and obtains true feature attribution weights according to

$$p = \frac{1}{1 + {e}^{- ( {w}_{0} + {w}_{1} {f}_{1} + {w}_{2} {f}_{2} + … )}} .$$

The greater the value of the term wᵢfᵢ, the larger is the exponential term of the Euler constant in the denominator, and accordingly, the closer p is to one. In the limit, as the exponential term goes to infinity, p converges to one. The greater the value of the term wᵢfᵢ, the more significant is the term's importance. Conversely, the smaller the value of the term wᵢfᵢ, the smaller is the exponential term of the Euler constant in the denominator, and accordingly, the closer p is to zero. In the limit, as the exponential term goes to infinity, p converges to zero. The smaller the value of the term wᵢfᵢ, the less significant is the term's importance.

FIG. 4 schematically illustrates certain operative aspects of MAIME framework 200 in generating a local explanation for multimodal AI instance 214. Illustratively, multimodal AI instance 214 is represented as a vector in two-dimensional vector space 400. In many real-world applications, a multimodal AI instance such as multimodal AI instance 214, would have many more features than two—possibly hundreds or thousands—and accordingly the corresponding vector space would be a much higher-dimensional vector space. Vector space 400 illustratively comprises thirteen vectors, multimodal AI model instance 214 and twelve perturbed instances 212, one outside and eleven inside neighborhood 402. Illustratively, smaller neighborhood 404 contains only three vectors.

Illustratively, vector space 400 includes hyperplanes 406 and 408, each corresponding to a different sparse linear model. Decision boundary 410 is generated by a black-box multimodal AI model. Note that if only the three perturbed instances inside neighborhood 404 have significant Shapley-adjusted weights and the Shapley-adjusted weights of the other perturbed instances are small, then the sparse linear model fitted to the three perturbed instances yields hyperplane 406. However, if all the perturbed instances inside neighborhood 402 are heavily weighted (by high-valued Shapley-adjusted weights), then the sparse linear model changes, and accordingly, the model yields hyperplane 408.

More generally, MAIME framework 200 generates a local explanation for multimodal AI instance 214 by determining weights corresponding to each perturbed instance in vector space 400 and using the weights to weight each perturbed instance to train an interpretable surrogate model, as described. The weights are converted from distances between corresponding features (illustratively two) of the perturbed samples and multimodal AI instance 214, the conversion performed using modality-specific kernel functions. The weights are updated to final weights by multiplying each by a corresponding Shapley value. The final, Shapley value-adjusted weights are used to train a surrogate sparse linear model to determine feature-importance values that explain generation of multimodal AI instance 214 by a multimodal AI model. Depending on the final weights of each perturbed instances, different linear models result for explaining decisions or predictions of the multimodal AI model. Compare, for example, hyperplane 406 generated by one sparse model with hyperplane 408 generated by another sparse model. The sparse linear models are interpretable in a manner that the black-box AI model that generates complex decision boundary 410 is not. Specifically, as illustrated in greater detail below, each of sparse linear models corresponding respectively to hyperplanes 406 and 408 can comprise a linear summation of weighted features. Each feature weight corresponds to importance of the feature. (See FIG. 7.)

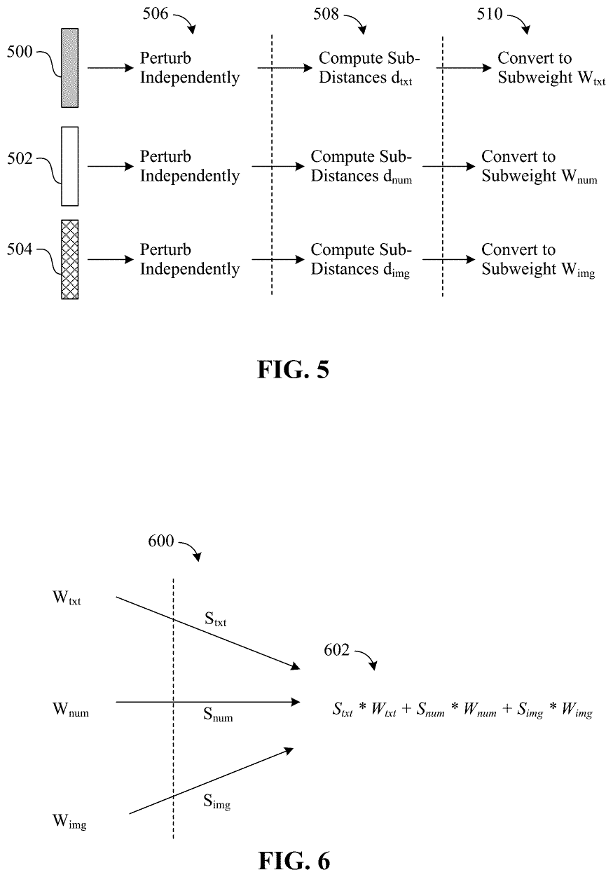

FIG. 5 schematically illustrates the generating of weights for perturbed instances assuming features having three distinct modalities, namely, text 500, numerical 502, and image 504. AI instance perturbator 202 generates perturbations 506 for each modality-specific feature independently. Distances 508 are computed for each of the features having distinct modalities. dₜₓₜ corresponds to a text modality distance, dₙᵤₘ corresponds to a numerical modality distance, and d_{img} corresponds to an image modality distance. Converter 206 converts the distances 508 to initial weights 510 using modality-specific kernel functions. Wₜₓₜ corresponds to a feature having text modality, Wₙᵤₘ corresponds to a feature having a numerical modality weight, and W_{img} corresponds to a feature having an image modality.

FIG. 6 schematically illustrates adjusting the weights by post-weighting the weights with modality-specific Shapley values. Www corresponding to the text modality weight, Wₙᵤₘ corresponding to the numerical modality weight, and W_{img} corresponding to the image modality weight are each multiplied by the modalities' game-theoretic Shapley values. Shapley values 600 are Sₜₓₜ, Sₙᵤₘ, and Sing corresponding, respectively, to the text, numerical, and image modalities. The post-weighting with corresponding Shapley values 600 yields final weight 602 for the perturbed multimodal AI instance 214, where final weight 602 is W=Sₜₓₜ*Wₜₓₜ+Sₙᵤₘ*Wₙᵤₘ+S_{img}*W_{img}.

Using final weights for a plurality of perturbed multimodal AI instances, surrogate model 220 is generated by surrogate model generator 210. Surrogate model 220 can be a sparse linear model. FIG. 7 schematically illustrates generating (e.g., implementing supervised learning) surrogate model 220 using plurality of perturbed instances 212, weighted by Shapley-adjusted, final weights. For N perturbed instances, N corresponding weights are used to generate N class-k predictions. In certain embodiments, surrogate model 220 is a ridge regression. Equation 700 illustrates a ridge regression model output. Equation 700 corresponds to a hyperplane in which each x, corresponds to a feature and each wᵢ indicates the importance of that feature in explaining the decision or prediction of an AI model that produced the multimodal AI instances.

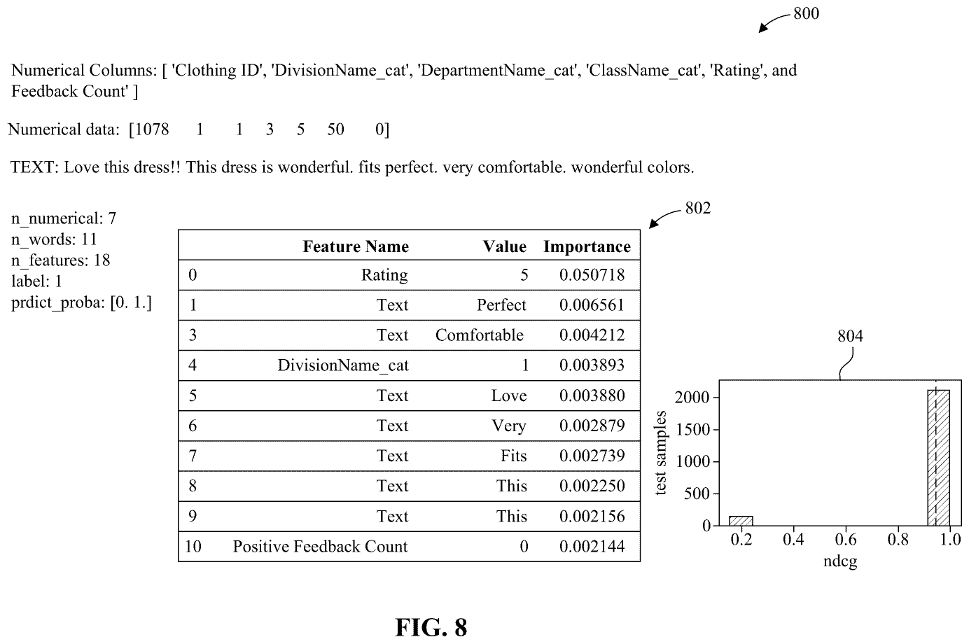

FIG. 8 illustrates an example output 800 of MAIME framework 200. Output 800 illustratively provides AI explainability for a prediction of a multimodal AI model designed to predict customer purchases based on customer reviews. The multimodal AI model makes the prediction based on data corresponding to two distinct modalities. The modalities are numerical data and text. The numerical data includes the categorical features Clothing ID (indicating clothing article), Division Name, Department Name, and Class Name. The numerical data also includes features indicating a customer rating, customer's age, and positive feedback count. The text features comprise word embeddings from customer reviews.

To determine the relative importance of each of the different features that determine a specific prediction (or local instance) by the multimodal AI model, AI instance perturbator 202 generates perturbed instances. To determine, for example, the importance of the feature customer rating (e.g., between one and five), AI instance perturbator 202 in some arrangements determines the distribution of ratings from the training set. If the ratings are assumed, for example, to be normally distributed with a sample mean and standard deviation, AI instance perturbator 202 can generate perturbed instances by randomly generating ratings based on the normal distribution. Or, for example, to determine the importance of text reviews, AI instance perturbator 202 in some arrangements can mask out certain words or combinations of words to generate multiple perturbed instances. In other arrangements, AI instance perturbator 202 can generate perturbed instances using a trained autoencoder or GAN, as described above.

Distance determiner 204 determines distances between the rating feature, word encoding features, and/or other features of the generated perturbed instances and the corresponding features of the local instance. Converter 206 converts the distances to weights using, for example, a modality-specific kernel function (e.g., exponential kernel function, Gaussian kernel function). Shapley value determiner 208 generates modality-specific Shapley values. Post-weighting the distance-based weights by the modality-specific Shapley values generates a set of final weights for weighting the prediction of each of the perturbed instances. Surrogate model generator 210 fits a machine learning model (e.g., ridge regression) to the weighted perturbed instances to generate surrogate model 220 (e.g., sparse linear model). The feature weights of surrogate model 220 correspond to feature importance weights.

The second column of Table 802 lists each of the features of multimodal AI model inputs, the third column gives the features' values, and the last column indicates the corresponding feature importance values determined by MAIME framework 200, as described.

True feature importance weights can be generated by a machine learning model (e.g., logistic regression model). The true feature importance weights can be compared with the feature importance weights of surrogate model 220 to assess surrogate model 220's accuracy. Using the comparisons, hyperparameters used to determine surrogate model 220 can be fine-tuned by MAIME framework 200. In certain embodiments, MAIME framework 200 fits a logistic regression model on multiple datasets with labeled samples from the multimodal AI model whose local instances MAIME framework 200 explains. MAIME framework 200 uses the fitted logistic regression model to compute true feature importance weights, that is, the weights computed by logistic regression model.

MAIME framework 200 evaluates an explainability algorithm on multiple datasets and compares these with explanations computed via the logistic regression. Different metrics can used for comparison. In certain embodiments, the metric is the Pearson correlation coefficient, for example. In other embodiments, for example, or a normalized discounted cumulative gain (NDCG) score is used. Based on the best scores, hyperparameters of the explainability algorithm implemented by MAIME can be determined. Graph 804 is an example NDCG score. The NDCG score indicates that the selected hyperparameters used and algorithm implemented by MAIME framework 200 yielded predictions of feature importance for a significant majority of samples with nearly 95 percent accuracy.

The terminology used herein is for the purpose of describing particular embodiments only and is not intended to be limiting. Notwithstanding, several definitions that apply throughout this document now will be presented.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating, by a processor, a plurality of perturbed instances, wherein each of the plurality of perturbed instances is generated by perturbing one or more encoded features of a multimodal AI model instance;
determining, by the processor for each of the plurality of perturbed instances, a distance between one or more encoded features of each perturbed instance and a corresponding one or more of the encoded features of the multimodal AI instance;
converting each distance to a weight using a kernel function;
determining for each weight a modality-specific Shapley value corresponding to a modality associated with each weight and post-weighting each weight with the modality-specific Shapley value associated with the weight to obtain a plurality of final weights; and
outputting an interpretable surrogate model based on the final weights.

2. The method of claim 1, wherein the generating independently perturbs the one or more features of each perturbed instance according to the modality of each of the one or more features.

3. The method of claim 1, wherein the generating is performed using at least one of a pretrained autoencoder or a generative adversarial network.

4. The method of claim 1, wherein the determining a distance uses a modality-specific distance metric corresponding to a modality of encoded features for which the distance is determined.

5. The method of claim 1, wherein the kernel function for converting each distance is a modality-specific kernel function corresponding to a modality of encoded features for which the distance is determined.

6. The method of claim 1, wherein the interpretable surrogate model is a sparse linear model comprising weights corresponding to feature importance values.

7. The method of claim 1, further comprising:
iteratively tuning hyperparameters of the interpretable surrogate model by comparing true explanations with outputs generated by the interpretable surrogate model.

8. The method of claim 7, wherein the true explanations comprise true feature attribution weights generated using a logistic regression model.

9. The method of method of claim 7, wherein values for the hyperparameters are determined based upon a Pearson correlation coefficient or a normalized discounted cumulative gain.

10. A system, comprising:
one or more processors configured to initiate operations including:
generating a plurality of perturbed instances, wherein each of the plurality of perturbed instances is generated by perturbing one or more encoded features of a multimodal AI model instance;
determining, for each of the plurality of perturbed instances, a distance between one or more encoded features of each perturbed instance and a corresponding one or more of the encoded features of the multimodal AI instance;
converting each distance to a weight using a kernel function;
determining for each weight a modality-specific Shapley value corresponding to a modality associated with each weight and post-weighting each weight with the modality-specific Shapley value associated with the weight to obtain a plurality of final weights; and
outputting an interpretable surrogate model based on the final weights.

11. The system of claim 10, wherein the generating independently perturbs the one or more features of each perturbed instance according to the modality of each of the one or more features.

12. The system of claim 10, wherein the generating is performed using at least one of a pretrained autoencoder or a generative adversarial network.

13. The system of claim 10, wherein the determining a distance uses a modality-specific distance metric corresponding to a modality of encoded features for which the distance is determined.

14. The system of claim 10, wherein the kernel function for converting each distance is a modality-specific kernel function corresponding to a modality of encoded features for which the distance is determined.

15. The system of claim 10, wherein the interpretable surrogate model is a sparse linear model comprising weights corresponding to feature importance values.

16. The system of claim 10, wherein the one or more processors are configured to initiate operations further including:
iteratively tuning hyperparameters of the interpretable surrogate model by comparing true explanations with outputs generated by the interpretable surrogate model.

17. The system of claim 16, wherein the true explanations comprise true feature attribution weights generated using a logistic regression model.

18. The system of claim 16, wherein values for the hyperparameters are determined based upon a Pearson correlation coefficient or a normalized discounted cumulative gain.

19. A computer program product, the computer program product comprising:
one or more computer-readable storage media and program instructions collectively stored on the one or more computer-readable storage media, the program instructions executable by a processor to cause the processor to initiate operations including:
generating a plurality of perturbed instances, wherein each of the plurality of perturbed instances is generated by perturbing one or more encoded features of a multimodal AI model instance;
determining, for each of the plurality of perturbed instances, a distance between one or more encoded features of each perturbed instance and a corresponding one or more of the encoded features of the multimodal AI instance;
converting each distance to a weight using a kernel function;
determining for each weight a modality-specific Shapley value corresponding to a modality associated with each weight and post-weighting each weight with the modality-specific Shapley value associated with the weight to obtain a plurality of final weights; and
outputting an interpretable surrogate model based on the final weights.

20. The computer program product of claim 19, wherein the program instructions are executable by the processor to cause the processor to initiate operations further including:
iteratively tuning hyperparameters of the interpretable surrogate model by comparing true explanations with outputs generated by the interpretable surrogate model.
